(19) United States
(12) Patent Application Publication
(10) Pub. No.: US 2007/0290983 A1
(43) Pub. Date: Dec. 20, 2007

(54) Output circuit of a source driver, and method of outputting data in a source driver

(76) Inventors: Hyung-Tae Kim, Hwaseong-si (KR); Seung-Hwan Baek, Seoul (KR)

Correspondence Address: LEE & MORSE, P.C., 3141 FAIRVIEW PARK DRIVE, SUITE 500, FALLS CHURCH, VA, 22042, US

(21) Appl. No.: 11/808,322

(22) Filed: Jun. 8, 2007

(30) Foreign Application Priority Data
Jun. 19, 2006 (KR) 10-2006-0054684

(51) Int. Cl. G09G 3/36

(52) U.S. Cl. 345/100

(57) ABSTRACT

An output circuit of a source driver may include a first buffer adapted to receive a first voltage and to output a first sub-voltage, a second buffer adapted to receive a second voltage and to output a second sub-voltage, the second sub-voltage being complementary with the first sub-voltage, and a sharing signal generator adapted to generate a sharing signal, the sharing signal being activated when the first sub-voltage level and the second sub-voltage level begin to change, and being inactivated when the first sub-voltage level and the second sub-voltage level reach a reference level, wherein the sharing signal controls a state of an electrical path between an output terminal of the first buffer and an output terminal of the second buffer.

### BACKGROUND OF THE INVENTION

1. Field of the Invention

Embodiments of the present invention relate to liquid crystal displays (LCDs), and more particularly, LCD devices including thin film transistors (TFTs), i.e., TFT-LCDs. More particularly, embodiments of the invention relate to an output circuit of a source driver in LCD devices and methods of outputting data in a source driver.

2. Description of the Related Art

A driver in a liquid crystal display (LCD) device may include a gate driver that drives gate lines (or row lines) and a source driver that drives source lines (or column lines) in order to drive a panel of the LCD device. When the gate driver applies a high voltage to the LCD device, and turns on a respective TFT(s), the source driver may output a source drive signal representing a respective color to the source lines, and the respective color(s) may be displayed on the LCD screen.

Conventional TFT-LCD devices generally suffer from problems, e.g., electromagnetic interference (EMI) due to, e.g., an abrupt increase in output current, and/or a slew rate of a signal input to a panel from a source driver.

### SUMMARY OF THE INVENTION

Embodiments of the present invention are therefore directed to LCDs, e.g., LCD-TFTs, an output circuit of a source driver in LCD devices, and methods of outputting data in a source driver of a LCD, which substantially overcome one or more of the problems due to the limitations and disadvantages of the related art.

It is therefore a feature of an embodiment of the present invention to provide an output circuit of a source driver that can control a slew rate.

It is therefore a separate feature of an embodiment of the present invention to provide a method of outputting data in a source driver that can control a slew rate.

It is therefore a separate feature of an embodiment of the present invention to provide a liquid crystal display (LCD) device that includes an output circuit of a source driver that can control a slew rate.

It is therefore a separate feature of an embodiment of the present invention to control a slew rate and decrease an influence of an EMI (Electromagnetic interference) by reducing a peak current.

At least one of the above and other features and advantages of embodiments of the present invention may be realized by providing an output circuit of a source driver, including a first buffer adapted to receive a first voltage and to output a first sub-voltage, a second buffer adapted to receive a second voltage and to output a second sub-voltage, the second sub-voltage being complementary with the first sub-voltage, and a sharing signal generator adapted to generate a sharing signal, the sharing signal being activated when the first sub-voltage level and the second sub-voltage level begin to change, and being inactivated when the first sub-voltage level and the second sub-voltage level reach a reference level, wherein the sharing signal controls a state of an electrical path between an output terminal of the first buffer and an output terminal of the second buffer.

The second voltage may be complementary to the first voltage. The output circuit may include a first switch adapted to selectively connect and disconnect the output terminal of the first buffer to a first output line, a second switch adapted to selectively connected and disconnect the output terminal of the second buffer to a second output line, and a sharing switch adapted to selectively connect and disconnect the first output line to the second output line in response to the sharing signal when the first switch and the second switch are turned off, such that the electrical path is established between the first output line and second output line when the sharing switch connects the first output line to the second output line.

The reference level of the first sub-voltage may be about half of high level of the first sub-voltage, and the reference level of the second sub-voltage may be about half of high level of the second sub-voltage. The first buffer and the second buffer may include a unity-gain amplifier. A time when the sharing signal is inactivated may be controlled by a bias level of the first and second buffers.

The sharing signal generator may include a comparator adapted to compare the first sub-voltage with the second sub-voltage and to output a comparison result, and a logic circuit adapted to receive the comparison result and an external clock signal and to output the sharing signal and an inversion signal of the sharing signal.

The logic circuit may include a NAND gate that outputs the inversion signal of the sharing signal. The logic circuit may include a third buffer adapted to invert the inversion signal that is output from the NAND gate and to output the sharing signal.

The first switch and the second switch may be controlled by the sharing signal and the inversion signal of the sharing signal. The sharing switch may be a transmission gate including a P-type transistor and a N-type transistor. The first switch and the second switch may be transmission gates and may each include a P-type transistor and a N-type transistor.

The source driver may be included in a liquid crystal display device, including a liquid crystal display panel including a plurality of gate lines and a plurality of data lines, a gate driver adapted to drive the gate lines of the liquid crystal display panel, and the source driver may be adapted to drive the data lines of the liquid crystal display.

At least one of the above and other features and advantages of embodiments of the present invention may be separately realized by providing a method of outputting data in a source driver, including outputting, to a first output line, a first sub-voltage based on a first voltage, outputting, to a second output line, a second sub-voltage based on a second voltage, the second sub-voltage being complementary with a first sub-voltage, and generating a sharing signal that is activated when the first sub-voltage level and the second sub-voltage level begin to change, and is inactivated when the first sub-voltage level and the second sub-voltage level reach at a reference level, the sharing signal controlling a state of an electrical path between the first output line and the second output line.

The second voltage may be complementary to the first voltage. The method may include controlling whether the first sub-voltage is applied to a first output line, controlling whether the second sub-voltage is applied to a second output line, and electrically connecting the first output line to the second output line in response to the sharing signal when the first sub-voltage and the second sub-voltage are not applied to the first output line and the second output line, respectively.

Generating the sharing signal may include outputting a comparison result by comparing the first sub-voltage with the second sub-voltage, and outputting the sharing signal and an inversion signal of the sharing signal based on the comparison result and an external clock signal.

At least one of the above and other features and advantages of embodiments of the present invention may be separately realized by providing an output circuit of a source driver, including a first buffer adapted to receive a first voltage and to output a first sub-voltage, a second buffer adapted to receive a second voltage and to output a second sub-voltage, the second sub-voltage being complementary with the first sub-voltage, and a sharing signal generating unit for generating a sharing signal for controlling a state of an electrical path between an output terminal of the first buffer and an output terminal of the second buffer.

The sharing signal may be activated when the first sub-voltage level and the second sub-voltage level begin to change, and may be inactivated when the first sub-voltage level and the second sub-voltage level reach a reference level.

The sharing signal generating unit may control the state of the electrical path between the output terminal of the first buffer and the output terminal of the second buffer to block the electrical path between the output terminal of the first buffer and the output terminal of the second buffer when the first sub-voltage and the second sub-voltage are substantially about one-half of a difference between a respective high level and low level thereof.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1A illustrates a circuit diagram of an exemplary output circuit of a source driver according to an exemplary embodiment of the present invention;

FIG. 1B illustrates a circuit diagram of an exemplary sharing signal generator employable by the output circuit of FIG. 1A according to an exemplary embodiment of the present invention;

FIG. 2 illustrates a timing diagram of a first sub-voltage Vs1's, a second sub-voltage Vs2′, a first output voltage OUT1′, and a second output voltage OUT2′ in response to a sharing signal SH′ and a switching signal S′ when an output circuit of a source driver does not include a sharing signal generator;

FIG. 3 illustrates a timing diagram of the first sub-voltage Vs1, the second sub-voltage Vs2, the first output voltage OUT1, and the second output voltage OUT2 in response to the sharing signal SH and the switching signal S when an output circuit of a source driver includes the sharing signal generator according to an exemplary embodiment of the present invention;

FIG. 4 illustrates a timing diagram of a change of a slew rate depending on a bias level of a buffer in the output circuit of a source driver according to the exemplary embodiment of the present invention shown in FIGS. 1A and 1B;

FIG. 5A illustrates a simulation diagram of noise of a power node in an output circuit of a conventional source driver and noise of a power node in an output circuit of the source driver employing one or more aspects of the present invention;

FIG. 5B illustrates a simulation diagram of EMI of a power node in an output circuit of a conventional source driver and EMI of a power node in an output circuit of the source driver employing one or more aspects of the present invention; and

FIG. 6 illustrates a block diagram of a LCD device including a source driver employing an output circuit employing one or more aspects of the present invention.

### DETAILED DESCRIPTION OF THE INVENTION

Korean Patent Application No. 2006-0054684, filed on Jun. 19, 2006, in the Korean Intellectual Property Office and entitled: “Output Circuit of a Source Driver, and Method of Outputting Data in a Source Driver,” is incorporated by reference herein in its entirety.

Embodiments of the present invention now will be described more fully with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. Like reference numerals refer to like elements throughout this application.

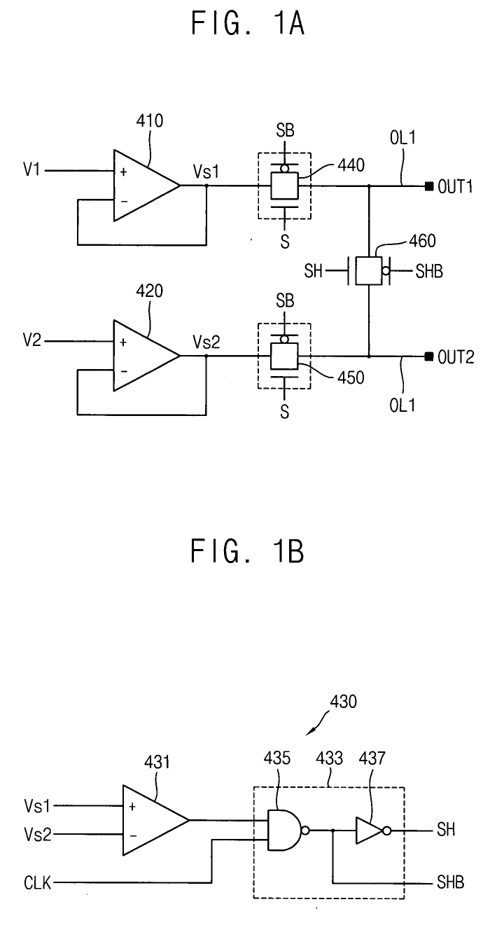

FIG. 1A illustrates a circuit diagram of an exemplary output circuit of a source driver according to an exemplary embodiment of the present invention, and FIG. 1B illustrates a circuit diagram of an exemplary sharing signal generator employable 430 by the output circuit of FIG. 1A according to an exemplary embodiment of the present invention.

Referring to FIG. 1A and FIG. 1B, an output circuit of a source driver according to one or more aspects of the present invention may include a first buffer 410, a second buffer 420, the sharing signal generator 430, a first switch 440, a second switch 450, and a sharing switch 460. Only exemplary embodiments of the first buffer 410, the second buffer 420, the first switch 440, and the second switch 450 in the output circuit of a source driver will be described below for convenience. The output circuit of an N bit source driver may include, e.g., N first buffers 410, N second buffers 420, N first switches 440, and N second switches 450. The sharing switch 460 may be implemented differently according to an exemplary embodiment of the present invention.

The first buffer 410 may receive a first voltage V1, and may output a first sub-voltage Vs1. The second buffer 420 may receive a second voltage V2, and may output a second sub-voltage Vs2. Each of the first buffer 410 and the second buffer 420 may be a unity-gain amplifier, and may be referred to as a voltage follower. In such cases, the first voltage V1 is identical and/or substantially identical to the first sub-voltage Vs1, and the second voltage V2 is identical and/or substantially identical to the second sub-voltage Vs2.

The first switch 440 may connect or disconnect the first sub-voltage Vs1 to a first output line OL1 in response to switching signal S and complementary switching signal SB, and the second switch 450 may connect or disconnect the second sub-voltage Vs2 to a second output line OL2 in response to the switching signal S and the complementary switching signal SB. The first switch 440 and the second switch 450 may be transmission gates that include a p-type transistor, e.g., a p-type-MOSFET (PMOS), and an n-type transistor, e.g., an n-type-MOSFET (NMOS). The complementary switching signal SB may be applied to a gate terminal of the PMOS transistor and the switching signal S may be applied to a gate terminal of NMOS. The switching signal S may be identical to and/or may correspond to a complementary sharing signal SHB. The complementary sharing signal SHB may be an inverse signal of a sharing signal SH. The complementary switching signal SB may be identical to and/or may correspond to the sharing signal SH.

Referring to FIG. 1B, the sharing signal generator 430 may include a comparator 431 and a logic circuit 433. The comparator 431 may receive the first sub-voltage Vs1 and the second sub-voltage Vs2, may compare the first sub-voltage Vs1 with the second sub-voltage Vs2, and may output ‘logic 1’ or ‘logic 0’ based on the comparison. Even if the first sub-voltage Vs1 and the second sub-voltage Vs2 may be applied to the opposite terminals, the output of the comparator 431 is based on a result of the comparison, i.e., is not changed. The logic circuit 433 may receive the output of the comparator 431 and an external clock signal CLK, and may output the sharing signal SH and the complementary sharing signal SHB. The logic circuit 433 may include a NAND gate 435 and a buffer 437. The NAND gate 435 may output the complementary sharing signal SHB. The buffer 437 may be an inverter, may invert the complementary sharing signal SHB, and may output the sharing signal SH.

Referring again to FIG. 1A, the sharing switch 460 may electrically connect the first output line OL1 with the second output line OL2 when the first switch 440 and the second switch 450 are turned off.

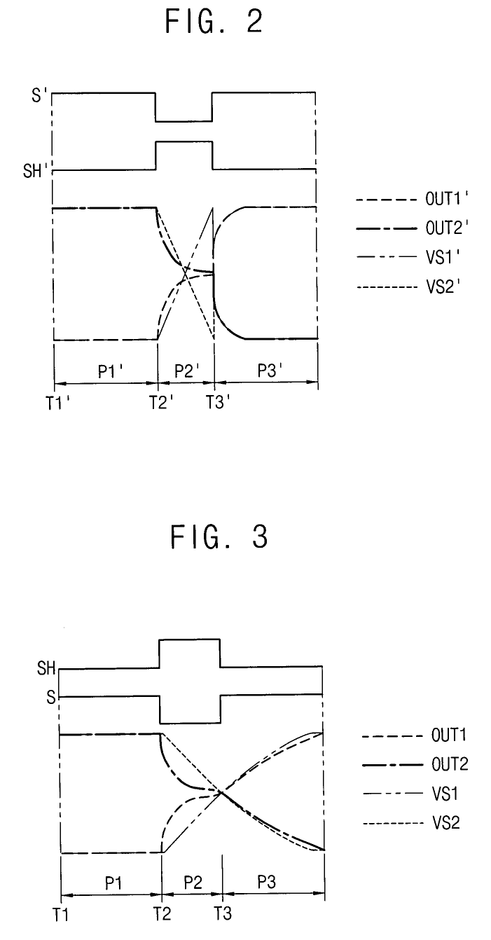

FIG. 2 illustrates a timing diagram of a first sub-voltage Vs1′, a second sub-voltage Vs2′, a first output voltage OUT1′, and a second output voltage OUT2′ in response to a sharing signal SH′ and a switching signal S′ when an output circuit of a source driver does not include the sharing signal generator 430. The switching signal S′ may be an inverse signal of a sharing signal SH′.

Referring to FIG. 1A, FIG. 1B and FIG. 2, at time T1′, the switching signal S′ may be ‘logic 1’ and the sharing signal SH′ may be ‘logic 0’. Therefore, the first switch 440 and the second switch 450 may be turned on, and the sharing switch 460 may be turned off. The first sub-voltage Vs1′ may be output through the first output line OL1 as a first output voltage OUT1′, and the second sub-voltage Vs2′ may be output through the second output line OL2 as the second output voltage OUT2′. These conditions may be maintained during a first period P1′.

Then, at time T2′, a level of the first sub-voltage Vs1′ and a level of the second sub-voltage Vs2′ may be changed, and the switching signal S′ may be changed to ‘logic 0’. Thus, the first switch 440 and the second switch 450 may be turned off. Therefore, the first sub-voltage Vs1′ may not be output to the first output line OL1, and the second sub-voltage Vs2′ may not be output to the second output line OL2. At this time, the first sub-voltage Vs1′ may be stored in the first output line OL1 as a parasitic capacitance, and the second sub-voltage Vs2′ may be stored in the second output line OL2 as a parasitic capacitance.

Also at time T2′, the sharing signal SH′, which may be an inverse of the switching signal S′, may be changed to ‘logic 1’. Therefore, the sharing switch 460 may be turned on, and the first output line OL1 may be electrically connected to the second output line OL2. Thus, a voltage stored in the first output line OL1 and a voltage stored in the second output line OL2 may be subjected to charge sharing, and resulting respective voltages may be respectively output through the first output line OL1 and the second output line OL2 as the first output voltage OUT1′ and the second voltage OUT2′. These conditions may be maintained during a second period P2′.

Thus, during the second period P2′, the first output voltage OUT1′ and the second output voltage OUT2′ may not follow the first sub-voltage Vs1′ and the second sub-voltage Vs2′, and the first output voltage OUT1′ and the second output voltage OUT2′ may converge together during and/or at an end of the second period P2′. Further, as shown in FIG. 2, at an end portion of the second period P2′, the first sub-voltage Vs1′ and the second sub-voltage Vs2′ may have values equal to or substantially equal to respective target values, e.g., the first sub-voltage Vs1′ may be equal to or substantially equal to a high level voltage and the second sub-voltage Vs2′ may be equal to or substantially equal to a low level voltage, while the first output voltage OUT1′ and the second output voltage OUT2′ may have substantially a same voltage corresponding to a value between the first sub-voltage Vs1′ and the second sub-voltage Vs2′, e.g., a value corresponding to an average of the first sub-voltage Vs1′ and the second sub-voltage Vs2′.

At time T3′, the switching signal S′ may be changed to ‘logic 1’ and the sharing signal SH′ may be changed to ‘logic 0’. Therefore, the first switch 440 and the second switch 450 may be turned on, and the sharing switch 460 may be turned off. Thus, the first sub-voltage Vs1′ may be connected to the first output line OL1, and the second sub-voltage Vs2′ may be connected to the second output line OL2. At this time, the first output voltage OUT1′ and the second output voltage OUT2′, which may be stored as parasitic capacitances, may be short-circuited.

Then, as shown in FIG. 2, after time T3′, output levels of the first output voltage OUT1′ and the second output voltage OUT2′ may relatively rapidly reach a respective target level. Under such conditions, noise, driver/signal malfunction and/or a power ripple(s) may occur and such noise, malfunction and/or power ripple may increase a peak current and/or EMI. These problems may occur at time T3′ because a slew rate of an amplifier that is used as the first buffer 410 and the second buffer 420 may be smaller than a toggling pulse of the sharing signal SH. More particularly, e.g., in such cases, because the slew operation of the amplifier may be finished at time T3′, the output voltages Vs1′ and Vs2′ of the amplifier may have already reached at a respective target voltage at time T3′.

In order to reduce and/or prevent the above problems, an output circuit of a source driver according to an exemplary embodiment of the present invention may include the sharing signal generator 430 of FIG. 1B.

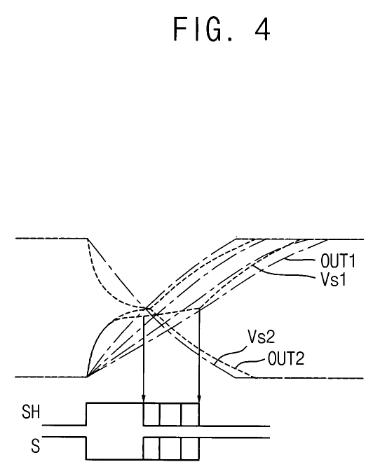

FIG. 3 illustrates a timing diagram of the first sub-voltage Vs1, the second sub-voltage Vs2, the first output voltage OUT1, and the second output voltage OUT2 in response to the sharing signal SH and the switching signal S when an output circuit of a source driver includes the sharing signal generator 430 according to an exemplary embodiment of the present invention.

For convenience, FIG. 3 will be described with reference to FIG. 1A and FIG. 1B. The switching signal S may be complementary with the sharing signal SH.

Referring to FIG. 3, at time T1, the switching signal S may be ‘logic 1’, and the sharing signal SH may be ‘logic 0’. Therefore, the first switch 440 and the second switch 450 may be turned on, and the first sub-voltage Vs1 may be output as the first output voltage OUT1 through the first output line OL1, and the second sub-voltage Vs2 may be output as the second output voltage OUT2 through the second output line OL2. These conditions may be maintained during the first period P1.

Then, at time T2, a level of the first sub-voltage Vs1 and a level second sub-voltage Vs2 may be changed, and the switching signal S may be changed to ‘logic 0’. Therefore, the first switch 440 and the second switch 450 may be turned off. Then, the first sub-voltage Vs1 may be disconnected from, i.e., may not be output to, the first output line OL1, and the second sub-voltage Vs2 may be disconnected from, i.e., may not be output to, the second output line OL2. At this time, the first sub-voltage Vs1 and the second sub-voltage Vs2 may be stored at the first output line OL1 and the second output line OL2 as a parasitic capacitance.

Also, at time T2, the sharing signal SH, which may be an inverse of the switching signal S, may be changed to ‘logic 1’. Therefore, the sharing switch 460 may be turned on. As a result, the first output line OL1 may be electrically connected to the second output line OL2, and a voltage stored at the first output line OL1 and a voltage stored at the second output line OL2 may be subjected to charge sharing, and resulting respective voltages may be respectively output through the first output line OL1 and the second output line OL2 as the first output voltage OUT1 and the second voltage OUT2, respectively. These conditions may be maintained during a second period P2.

Thus, during the second period P2, the first output voltage OUT1 and the second output voltage OUT2 may not follow the first sub-voltage Vs1 and the second sub-voltage Vs2, and the first output voltage OUT1 and the second output voltage OUT2 may converge together during and/or at an end of the second period P2. More particularly, in some embodiments of the invention, as shown in FIG. 3, at an end portion of the second period P2, i.e., at time T3, the first sub-voltage Vs1 and the second sub-voltage Vs2 may have the same and/or substantially similar values, and the values of the first sub-voltage Vs and the second sub-voltage Vs2 may be the same as and/or substantially similar to values of each of the first output voltage OUT1 and the second output voltage OUT2. In other embodiments of the invention, e.g., the time T3 when the sharing signal may change to a ‘logic 0’ may occur when, e.g., one or both of the first sub-voltage Vs1 and the second sub-voltage Vs2 reach a same or a respective reference value. More particularly, e.g., in cases in which the same reference value corresponding to the first sub-voltage Vs1 and the second sub-voltage Vs2 may be a value that is exactly and/or substantially average of the first sub-voltage Vs1 and the second sub-voltage Vs2. In other cases, e.g., a reference value corresponding to the first sub-voltage Vs1 may be exactly or substantially half of a difference between a maximum and minimum value of the first voltage V1 or the first sub-voltage Vs1, while the reference value corresponding to the second sub-voltage Vs2 may be exactly and/or substantially half of a difference between a maximum and minimum value of the second voltage V2 or the second sub-voltage Vs2.

Embodiments of the invention are not limited to such exemplary reference value(s). Further, in some embodiments of the invention, the sharing signal SH may not be changed exactly at a time when, e.g., the first and/or second sub-voltage reaches the respective reference level, i.e., the first and/or second sub-voltage may reach the respective reference level and continue rising or dropping until the both reach the respective reference level and/or at least a predetermined time lapses. In some embodiments of the invention, e.g., various reference level(s) and/or trigger conditions may be used to change the sharing signal SH and the sharing signal SH may be changed prior to at least one or all of the respective sub-voltages reaching respective target values, e.g., maximum or minimum values, thereof.

Exemplary operation of the sharing signal generator 430 during the first and second periods P1, P2 will be described below. For example, when the first sub-voltage Vs1 is input through a plus terminal of the comparator 431, and the second sub-voltage Vs2 is input through a minus terminal of the comparator 431, an output of the comparator 431 may be ‘logic 1’ during the first period and second periods P1, P2. The output of the comparator 431 and an external clock signal CLK may be inputted into a NAND gate 435 of the logic circuit 433. When at least one among the output of the comparator 431 and the external clock signal CLK is ‘logic 0’, the sharing signal may become ‘logic 0’. More particularly, e.g., when a relationship between the first sub-voltage Vs1 and the second sub-voltage Vs2 changes, e.g., the first sub-voltage Vs1 is the same as the second sub-voltage Vs2 or reversed, e.g., the first sub-voltage Vs1 changes from having a smaller magnitude to a larger magnitude than the second sub-voltage Vs2, the output of the comparator 431 may change to ‘logic 0’. As a result, the sharing signal SH may change to ‘logic 0’, as described with regard to time T3. Further, at time T3, the switching signal S may change to ‘logic 1’.

Accordingly, in some embodiments of the invention, as shown in FIG. 3, because magnitudes of the first sub-voltage Vs1 and the second sub-voltage Vs2 may be reversed at a time T3, the sharing signal SH may be changed to ‘logic 0’ as a result of the comparator 431 of the sharing signal generator 430. Therefore, the sharing switch 460 may be turned off, and the first switch 440 and the second switch 450 may be turned on. Thus, the first sub-voltage Vs1 may be connected to the first output line OL1, and the second sub-voltage Vs2 may be connected to the second output line OL2. In some embodiments of the invention, a level of the first output voltage OUT1 before the sharing switch 460 is turned off may be the same as and/or substantially the same as a level of the first sub-voltage Vs1 right after the sharing switch 460 is turned off, and a level of the second output voltage OUT2 before the sharing switch 460 is turned off may be the same as and/or substantially the same as a level of the second sub-voltage Vs2 right after the sharing switch 460 is turned off. Therefore, EMI may be reduced by decreasing peak current due to a difference in voltage level(s). Noise that may be generated when, e.g., the output buffers 410 and 420 simultaneously and/or substantially simultaneously operate at maximum value(s) of an operation range may also be reduced.

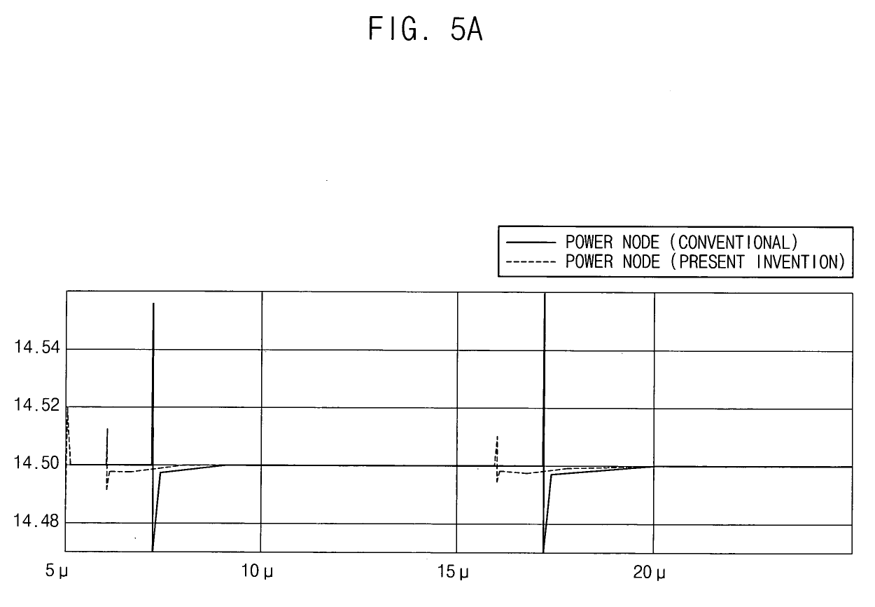

FIG. 4 illustrates a timing diagram of a change of a slew rate depending on a bias level of a buffer in an output circuit of a source driver employing one or more aspects of the present invention.

Referring to FIG. 4, an off-timing of the sharing switch 460 may be controlled based on a slew rate of a buffer controlling a bias level of the buffer. Thus, embodiments of the invention may control the off-timing of the sharing switch 460 such that the sharing switch 460 may be turned off at about a time when, e.g., the first sub-voltage Vs1 and the second sub-voltage Vs2 reach a same value and/or a relationship thereof reverses, which may thereby prevent the first sub-voltage Vs1 and/or the second sub-voltage Vs2 from reaching target and/or maximum values, i.e., reducing a corresponding current(s).

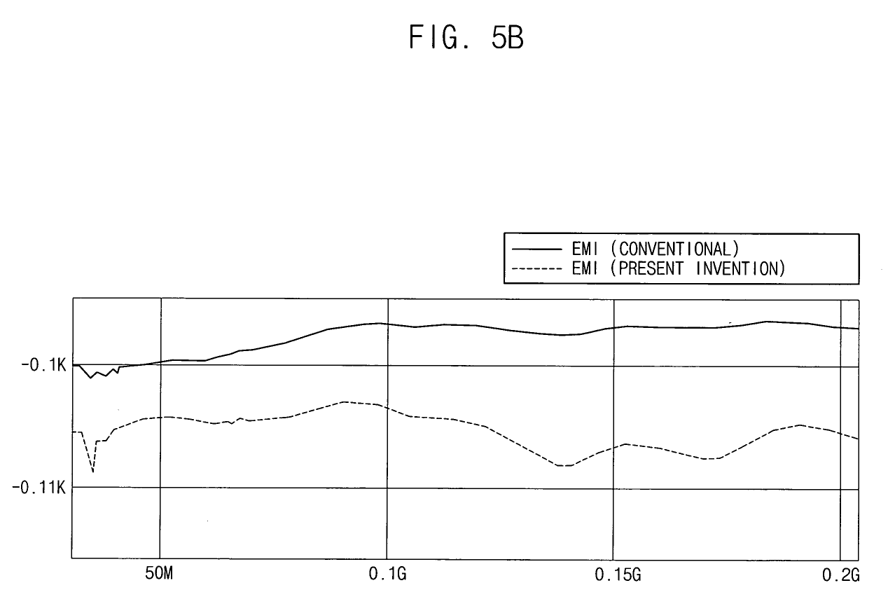

FIG. 5A illustrates a simulation diagram of noise of a power node in an output circuit of a conventional source driver and noise of a power node in an output circuit of a source driver employing one or more aspects of the present invention.

Referring to FIG. 5A, the noise generated in the output circuit of a source driver employing one or more aspects of the invention is significantly reduced, as compared to the noise generated in the conventional source driver, e.g., a conventional source driving not including a sharing signal generator.

FIG. 5B illustrates a simulation diagram of EMI of a power node in an output circuit of a conventional source driver and EMI of a power node in an output circuit of a source driver employing one or more aspects of the present invention.

Referring to FIG. 5B, embodiments of the invention may enable EMI to be significantly reduced by preventing a rapid increase, i.e., slowing a rate of change of voltage signals, in the output circuit of a source driver.

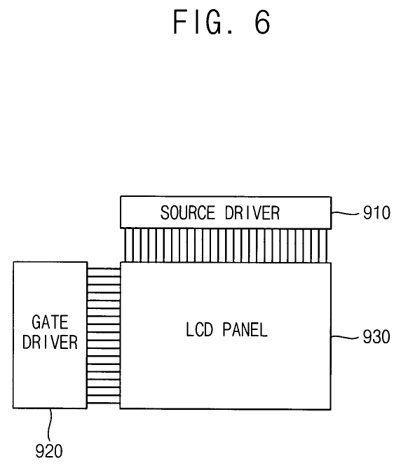

FIG. 6 illustrates a diagram of a LCD device including a source driver including an output circuit employing one or more aspects of the present invention.

Referring to FIG. 6, the LCD device may include a source driver 910 including the output circuit according to one or more aspects of the invention, a gate driver 920, and a LCD panel 930.

The source driver 910 may include the output circuit of FIG. 1A including the sharing signal generator 430 of FIG. 1B. The source driver 910 may also include buffers and switches. In some embodiments of the invention, a number of the buffers and the switches may be the same as a number of channels of the source driver 910.

Embodiments of the present invention may provide an output circuit and the method of outputting data in the source driver, which can control a slew rate and/or reduce an influence of an EMI by reducing a peak current.

In accordance with example embodiments of the present invention, the LCD device including the output circuit of the source driver can control a slew rate and reduce an influence of an EMI by reducing a peak current.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An output circuit of a source driver, comprising:
a first buffer adapted to receive a first voltage and to output a first sub-voltage;
a second buffer adapted to receive a second voltage and to output a second sub-voltage, the second sub-voltage being complementary with the first sub-voltage; and
a sharing signal generator adapted to generate a sharing signal, the sharing signal being activated when the first sub-voltage level and the second sub-voltage level begin to change, and being inactivated when the first sub-voltage level and the second sub-voltage level reach a reference level, wherein the sharing signal controls a state of an electrical path between an output terminal of the first buffer and an output terminal of the second buffer.

2. The output circuit as claimed in claim 1, wherein the second voltage is complementary to the first voltage.

3. The output circuit as claimed in claim 1, further comprising:
a first switch adapted to selectively connect and disconnect the output terminal of the first buffer to a first output line;
a second switch adapted to selectively connected and disconnect the output terminal of the second buffer to a second output line; and
a sharing switch adapted to selectively connect and disconnect the first output line to the second output line in response to the sharing signal when the first switch and the second switch are turned off, such that the electrical path is established between the first output line and second output line when the sharing switch connects the first output line to the second output line.

4. The output circuit as claimed in claim 3, wherein the first switch and the second switch are controlled by the sharing signal and the inversion signal of the sharing signal.

5. The output circuit as claimed in claim 4, wherein the sharing switch is a transmission gate including a P-type transistor and a N-type transistor.

6. The output circuit as claimed in claim 3, wherein the first switch and the second switch are transmission gates each including a P-type transistor and a N-type transistor.

7. The output circuit as claimed in claim 1, wherein the reference level of the first sub-voltage is half of high level of the first sub-voltage, and the reference level of the second sub-voltage is half of high level of the second sub-voltage.

8. The output circuit as claimed in claim 1, wherein the first buffer and the second buffer include a unity-gain amplifier.

9. The output circuit as claimed in claim 8, wherein a timing when the sharing signal is inactivated is controlled by a bias level of the first and second buffers.

10. The output circuit as claimed in claim 1, wherein the sharing signal generator includes:
a comparator adapted to compare the first sub-voltage with the second sub-voltage and to output a comparison result; and
a logic circuit adapted to receive the comparison result and an external clock signal and to output the sharing signal and an inversion signal of the sharing signal.

11. The output circuit as claimed in claim 10, wherein the logic circuit includes a NAND gate that outputs the inversion signal of the sharing signal.

12. The output circuit as claimed in claim 11, wherein the logic circuit further includes a third buffer adapted to invert the inversion signal that is outputted from the NAND gate and to output the sharing signal.

13. A liquid crystal display device, comprising:
a liquid crystal display panel including a plurality of gate lines and a plurality of data lines;
a gate driver adapted to drive the gate lines of the liquid crystal display panel; and
the source driver as claimed in claim 1, wherein the source driver is adapted to drive the data lines of the liquid crystal display.

14. A method of outputting data in a source driver, comprising:
outputting, to a first output line, a first sub-voltage based on a first voltage;
outputting, to a second output line, a second sub-voltage based on a second voltage, the second sub-voltage being complementary with a first sub-voltage; and
generating a sharing signal that is activated when the first sub-voltage level and the second sub-voltage level begin to change, and is inactivated when the first sub-voltage level and the second sub-voltage level reach at a reference level, the sharing signal controlling a state of an electrical path between the first output line and the second output line.

15. The method as claimed in claim 14, wherein the second voltage is complementary to the first voltage.

16. The method as claimed in claim 14, further comprising:
controlling whether the first sub-voltage is applied to a first output line;
controlling whether the second sub-voltage is applied to a second output line; and
electrically connecting the first output line to the second output line in response to the sharing signal when the first sub-voltage and the second sub-voltage are not applied to the first output line and the second output line, respectively.

17. The method as claimed in claim 14, wherein generating the sharing signal includes:
outputting a comparison result by comparing the first sub-voltage with the second sub-voltage; and
outputting the sharing signal and an inversion signal of the sharing signal based on the comparison result and an external clock signal.

18. An output circuit of a source driver, comprising:
a first buffer adapted to receive a first voltage and to output a first sub-voltage;
a second buffer adapted to receive a second voltage and to output a second sub-voltage, the second sub-voltage being complementary with the first sub-voltage; and
a sharing signal generating means for generating a sharing signal for controlling a state of an electrical path between an output terminal of the first buffer and an output terminal of the second buffer.

19. The output circuit as claimed in claim 18, wherein the sharing signal is activated when the first sub-voltage level and the second sub-voltage level begin to change, and is inactivated when the first sub-voltage level and the second sub-voltage level reach a reference level.

20. The output circuit as claimed in claim 18, wherein the sharing signal generating means controls the state of the electrical path between the output terminal of the first buffer and the output terminal of the second buffer to block the electrical path between the output terminal of the first buffer and the output terminal of the second buffer when the first sub-voltage and the second sub-voltage are substantially about one-half of a difference between a respective high level and low level thereof.
